(19) United States
(12) Patent Application Publication
(10) Pub. No.: US 2005/0205722 A1
(43) Pub. Date: Sep. 22, 2005

(54) Pipe and tube support

(76) Inventor: Carey Krueger, Newton, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/047,466

(22) Filed: Jan. 31, 2005

Related U.S. Application Data
(60) Provisional application No. 60/540,178, filed on Jan. 29, 2004.

(51) Int. Cl. F16L 3/00; E21F 17/02

(52) U.S. Cl. 248/62

(57) ABSTRACT

A pipe and tube support apparatus is provided. The support includes a housing having upper and lower housing portions that are hingedly interconnected at one end to provide a clam-shell like configuration. A fastener is provided opposite the hinged interconnection to lock the housing in a closed position about a tube or a pipe. Upper and lower liners are positioned within the upper and lower housing portions to provide a cylindrical surface for contacting a pipe or tube. An interconnection is provided between the housing and a support rod and allows the housing to be at an angle to accommodate a sloped pipe or tube.

### RELATED APPLICATIONS

This application claims the benefit of U.S. Provisional Application Ser. No. 60/540,178 filed Jan. 29, 2004, the entire disclosure of which is expressly incorporated herein by reference.

### BACKGROUND OF THE INVENTION

1. Field of the Invention

The present invention relates to a pipe and tube support.

2. Related Art

Pipe and tubing systems are widely used in various industries including the food, chemical, electronics, industrial, biotechnology, and pharmaceuticals industries. One pipe support system used in the past is shown in U.S. Pat. No. 4,442,990. It includes upper and lower halves that are fastened together with bolts to position the upper and lower halves about a pipe. A mounting device, such as a suspension rod extending from a support surface, is provided for positioning the pipe support, and the pipe, at a specific location.

It is desirable for pipe and tube supports to include smooth uninterrupted surfaces that can be easily cleaned to prevent contamination. It is also desirable that such pipe and tube supports are easy to install to minimize installation time and costs. Another desirable feature of such a pipe and tube support is to accommodate a pipe or tube having a slope for drainability and run-off. The slope is required for flow and typically pipe and tube supports are adjusted to different heights along the length of the pipe to accommodate the slope of the pipe or tube. However, the lower surface of the pipe and tube support that contacts the pipe is normally maintained parallel to the support surface and at an angle to the slope of the pipe or tube. Because of the slope of the pipe running through the support, areas of pressure can occur creating internal stresses on the tubes to be supported.

Accordingly, what would be desirable, but has not yet been provided, is a pipe and tube support that is easily installed, provides smooth, uninterrupted surfaces that can be easily cleaned to prevent contamination, and allows for rotation and tilting to accommodate pipes or tube systems of various slopes and configurations.

### SUMMARY OF THE INVENTION

The present invention provides a pipe and tube support apparatus. The apparatus comprises a housing including an upper housing portion, a lower housing portion hingedly interconnected to the upper housing portion, and a fastener for fastening the upper and lower housing portions in a closed position; upper and lower liners positioned within the upper and lower hosing portions to form a cylindrical inner surface; means for interconnecting the housing to a suspension member; and means for angling the housing with respect to the suspension member to accommodate a sloping pipe or tube. In one embodiment, the upper housing portion includes a dome-shaped protrusion with an elongate aperture through which a dome-headed bolt is inserted and is threadably engageable with a suspension rod. To provide space for the housing to be angled with respect to the suspension rod, the dome-headed bolt could include a shoulder that prevents over-engagement of the bolt with the rod. A tension ring in the form of an O-ring could be provided between the dome-shaped protrusion and the suspension rod. The lower end of the suspension rod can be configured to match the dome-shaped protrusion. Alternatively, a collar can be provided about the bolt and within the dome-shaped protrusion to prevent over-engagement of the bolt within the suspension rod.

The present invention also provides a method for supporting a pipe or tube, comprising the steps of: providing a housing having an upper housing portion and a lower housing portion hingedly interconnected at first ends and releasably fastenable at opposite ends; snapping liners into position on interior surfaces of the housing; positioning a pipe or tube against the liner; fastening the housing and liner about the pipe or tube; and suspending the housing from a surface.

### BRIEF DESCRIPTION OF THE DRAWINGS

Other important objects and features of the invention will be apparent from the following Detailed Description of the Invention taken in connection with the accompanying drawings in which:

FIG. 1 is a cross-sectional view of the pipe and tube support of the present invention.

FIG. 2 is a cross-sectional view of the pipe and tube support of the present invention, taken along the line 2-2 of FIG. 1.

FIG. 3 is a cross-sectional view of the pipe and tube support shown in FIG. 1, with the swivel connection positioned at an angle to allow the pipe and tube support to tilt to accommodate a sloping pipe or tube.

FIG. 4 is a side view of the lower portion of the housing of the present invention.

FIG. 5 is a side view and FIG. 6 is a front view showing a liner for the housing according to the present invention.

FIG. 7 is an end view of the liner shown in FIGS. 5 and 6.

FIG. 8 is a perspective view showing engagement of the liner with the housing.

FIG. 9 is a partial cross-sectional view of an alternate embodiment of the pipe and tube support of the present invention.

FIG. 10 is a partial cross-sectional view of the pipe and tube support of FIG. 9 interconnected with a suspension rod mounted to a support structure.

FIG. 11A is a side view of the upper portion of the housing of the pipe and tube support shown in FIG. 10, and FIG. 11B is a top view thereof.

FIG. 12A is a side view of the lower portion of the housing of the pipe and tube support shown in FIG. 10, and FIG. 12B is a bottom view thereof.

FIG. 13A shows an alternate liner according to the present invention that can be positioned within the lower and upper portions of the housing. FIG. 13B shows an insert for the liner. FIG. 13C shows stops formed as part of the liner.

FIG. 14 is a partial cross-sectional view of another embodiment of the pipe and tube support of the present invention.

FIG. 15 is a view showing the pipe and tube support of FIG. 14 in greater detail.

FIG. 16 is an exploded view of the pipe and tube support shown in FIG. 15.

FIG. 17 is a perspective view of the pipe and tube support shown in FIG. 10 supporting a pipe.

FIG. 18 is a view of a pipe and tube support with another connection to a suspension rod.

FIG. 19 is a cross-sectional view of the upper housing shown in FIG. 18.

FIG. 20 is a cross-sectional view of the lower end of the suspension rod shown in FIG. 18.

FIG. 21 is a view of an attachment bolt.

FIG. 22 is a perspective view showing another embodiment of the pipe and tube support of the present invention.

### DETAILED DESCRIPTION OF THE INVENTION

The present invention provides a pipe and tube support apparatus. The support includes a housing having upper and lower housing portions that are hingedly interconnected at one end to provide a clam-shell like configuration. A fastener is provided opposite the hinged interconnection to lock the housing in a closed position about a tube or a pipe. A liner is positioned against the inner surfaces of the housing, and provides a smooth cylindrical surface for contacting the tube or pipe. The liner comprises upper and lower liner portions that can be snapped in position against the upper and lower housing portions. An interconnection is provided between the housing and a support rod and allows the housing to swivel and rock with respect to the support rod.

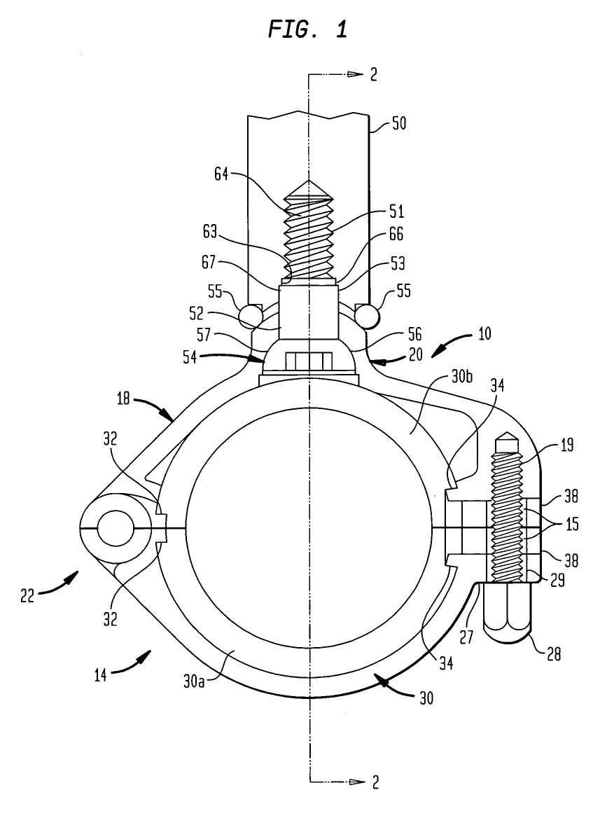

FIG. 1 is a cross-sectional view of the pipe and tube support of the present invention. The support comprises a housing, indicated generally at 10, having a lower housing portion 14 and an upper housing portion 18. The housing portions 14 and 18 are joined by a hinge 22 to allow the housing 10 to open in a clam-shell like fashion. Both housing portions include fastening apertures 19 and 29, respectively, opposite the hinge 22, which are aligned and engaged by a fastening bolt 28, such as an acorn screw, to retain the housing 10 in a closed configuration. A liner or insert 30, such as a plastic insert, is retained within the housing 10 and provides a surface that contacts a pipe or tube extending through the housing. The surfaces of the upper and lower housings can be rounded off to provide a smooth exterior.

A swivel connection is provided between the housing 10 and a suspension rod 50, which could be connected to any desired support surface. This connection allows for tilt and swivel movement between the housing 10 and the suspension rod 50. The upper housing portion 18 includes a domed protrusion 20 having a domed interior 56. The protrusion 20 in the upper housing portion 18 includes an aperture 52 at the apex. An attachment bolt 54 having a domed-shaped head 57 and a cylindrical body portion 53 extends through the aperture 52 in the upper housing portion 18. The domed-shaped head 57 is sized and shaped to be received within the domed protrusion 20. The cylindrical portion 53 ends at shoulder 63 and threaded portion 64 extends therefrom and can be threadably engaged with threads 51 within suspension rod 50. The threads 51 within the suspension rod 50 are recessed from the lower end. A cylindrical bore 67 may be provided in the rod 50, and a step down 66 from cylindrical bore 67 coacts with the shoulder 63 on bolt 54 to limit the extent to which the bolt can be engaged with suspension rod 50. The lower end of the suspension rod has a domed recess complementary to the domed protrusion 20. A shoulder may be provided for receiving an O-ring 55 that is positioned between the suspension rod 50 and the domed protrusion 20 of the upper housing 18. The O-ring 55 permits relative movement of the housing 18 with respect to the suspension rod 50, but acts to bear against the domed protrusion 20 to prevent rattling and generally retain the housing 10 at a desired orientation with respect to the suspension rod 50. The O-ring can be any suitable size or made of any suitable material, for example a No. 206 O-ring made by Rubberfab Mold and Gasket, Andover, N.J. The O-ring can be made of EPDM (Ethylenepropylene-Dienemonomer) for heat tolerance and compressive strength requirements.

The liner 30 comprises lower and upper liner portions 30a and 30b, respectively, for positioning within the lower housing portion 14 and upper housing portion 18. The liner 30 includes a smooth interior surface for extending about, or engaging, a pipe, not shown. The lower and upper liners 30a and 30b are positioned within the lower and upper housings 14 and 18. Grooves are formed on exterior surfaces of the lower and upper liners 30a, 30b to engage with shoulders on the inner surfaces of the lower and upper housing portions 14 and 18 for seating the liners 30a, 30b in the housing. Tabs 32 are provided on the hinged edges of the lower and upper housing portions 14 and 18 for engagement with end recesses formed in the lower and upper liner portions 30a and 30b. Additionally, tabs 34 are provided on the fastening ends of the lower and upper housing portions 14 and 18 for engagement with slots formed in the lower and upper liner portions 30a and 30b to engage the lower and upper liner portions 30a and 30b into place in the lower and upper housing portions 14 and 18. The lower and upper liner portions 30a, 30b include fastening arms 38 extending between the lower and upper housings 14 and 18 at the fastening ends. The fastening arms 38 each include aligned apertures 15 for accommodating fastening bolt 28, such as an acorn bolt which is easy to manipulate in the field.

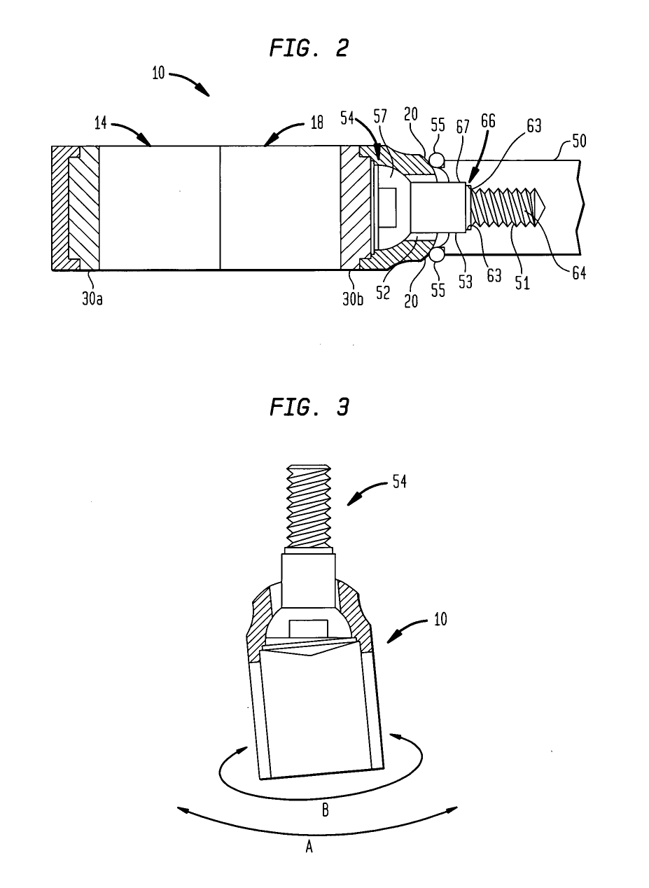

FIG. 2 is a cross-sectional view of the pipe and tube support of the present invention, taken along the line 2-2 of FIG. 1. As can be seen, the aperture 52 can be elongate, with the long axis of the aperture 52 perpendicular to the transverse plane of the housing 10 (i.e., the long axis extends side to side on the view shown in FIG. 2) to allow angulation of the housing 10 with respect to the bolt 54, and the suspension rod, to permit the housing 10 to be angled to accommodate a downwardly sloping pipe or tube. Importantly, there must be some clearance between the bolt 54 and the aperture 52 to allow for angular movement. This can be seen in greater detail in FIG. 3, wherein the housing 10 is positioned at an angle with respect to the bolt 54. The housing 10 can be angled in the general direction indicated by arrow A. Further, the housing 10 can swivel as indicated by arrow B.

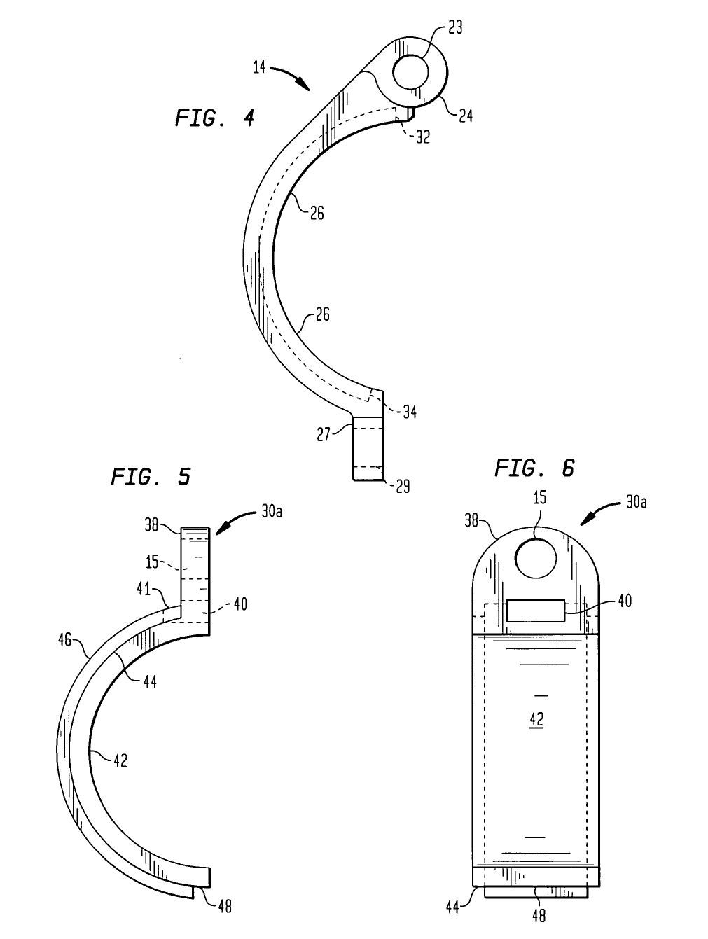

FIG. 4 is a side view of the lower housing portion 14 of the present invention. The lower portion 14 includes a pin aperture for receiving a hinge pin, not shown, that allows the upper and lower portions 14 and 18 to open and close in a clam-shell like configuration. The tabs 32 coact with a groove formed on an end of the lower liner portion and tab 34 coacts with a slot formed in the opposite end of the lower liner portion to retain the lower liner portion into place against the lower housing portion 14. The lower housing portion 14 includes shoulders 26 disposed on opposite sides of the housing portion 14. The fastening end 27 of the lower housing portion 14 includes an aperture 29 through which a fastening screw is inserted. The upper housing portion 18 similarly includes tabs 32 and 34 for interacting with the upper liner portion to retain the upper liner against the upper housing portion 18.

FIGS. 5 is a side view and FIG. 6 is a front view of liner portion 30a, liner 30b being identical thereto. Liner portion 30a includes a fastening end 38 with an aperture 15 for receiving the fastening bolt 28 as shown in FIG. 1. A slot 41 is provided to receive the tab 34 of the lower or upper housing portions 14 and 18. For ease of manufacture during molding, a channel 40 can extend from the slot 41. The liner includes a smooth inner surface 42 for contacting a pipe or a tube. Grooves 44 are provided on outer surface 46 of the liner and sit against the shoulders 26 of the lower and upper housing portions 14 and 18. An end groove 48 coacts with the tabs 32 of the lower and upper housing portions 14 and 18, which along with the coaction of the tab 34 and slot 41, retains the liner portion 30a to one of the lower or upper housing portions 14 or 18. As such, the liner snaps onto the housing and is retained on the housing by virtue of a pressure fit. The liner can be removed from the housing by moving the ends of the liner together until the slot 41 is dispensed from tab 34. The configuration of the grooves, slots, and tabs can be varied as desired without departing from the scope of the invention.

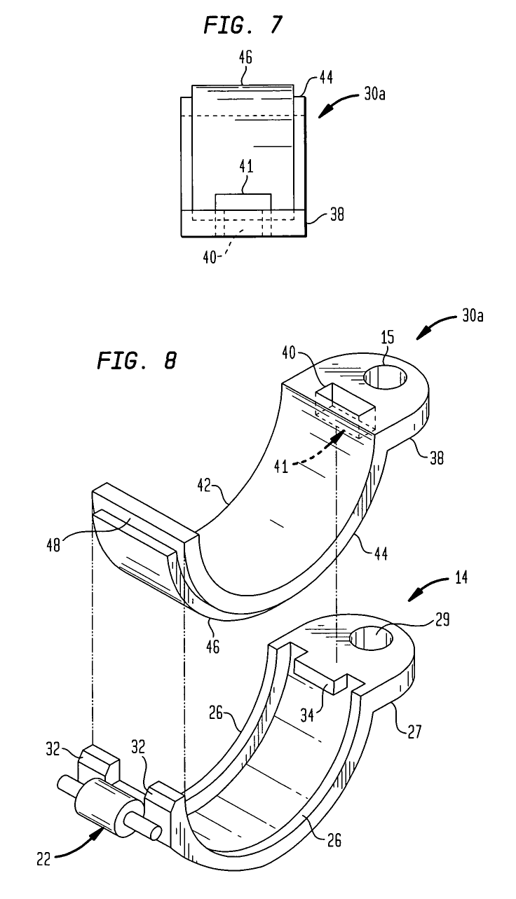

FIG. 7 is an end view of liner 30a showing slot 41.

FIG. 8 is a perspective view showing engagement of the bottom liner portion 30a with the bottom housing portion 14. To engage the liner portion 30a in position against the housing portion 14, the end groove 48 of the liner portion 30a is positioned on the tabs 32. Pressure is applied to the fastening arm 38 of liner portion 30a with respect to the housing portion 14 to move the ends of the liner towards each other until slot 41 can pass over tab 34 and the liner snaps into position on the housing to retain the liner in place. The grooves 44 of the liner 30a are thereby positioned on the shoulders 26 of housing portion 14. When the liner 30a is in place, the apertures 15 and 29 are aligned to allow a fastening bolt to be inserted therethrough. The upper liner portion 30b is engaged in position against the upper housing portion 18 in similar fashion.

It should be noted that the liner of the present invention can be made of any desired material. It is desirable to use materials that can withstand high temperatures. Such materials include Amodel (Polyphthalamide) made by Solvay Advanced Polymers, (Alpharetta, Ga.), Zeotherm, and Polyamide 66. Any suitable material, of course, can be used. The liner can be made by injection molding, or other suitable process. Also, liners can have different thicknesses to provide various internal diameters so that multiple liners can be inserted into the lower and upper housings to provide pipe and tube supports for accommodating different size pipes and tubes.

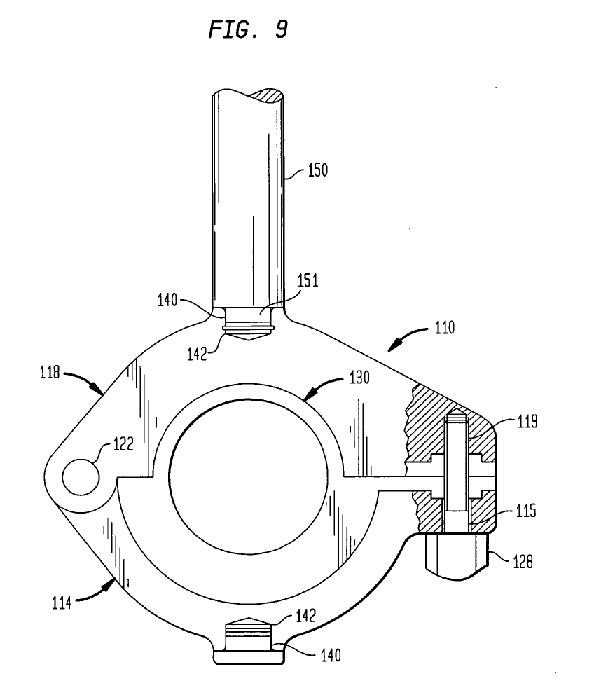

FIG. 9 is a partial cross-sectional view of an another embodiment of the present invention, indicated generally at 110. The housing 110 and includes a lower housing portion 114 and an upper housing 118. Both of the housings have hinge apertures at one end of the housing to allow the housing to open in a clam-shell like fashion. Both housings include fastening apertures 115 and 119 respectively, at the other side of the hinge, and which are aligned and engaged by a fastening bolt 128 to retain the housing 110 in a closed configuration. An insert 130, or liner, is retained within the housing 110 and provides a surface that contacts a pipe or tube extending through the housing. The upper and lower housing portions 114 and 118 include receptacles 140, with snap rings 142, for engagement with a suspension rod having a mating snap ring portion 151. This snap ring connection allows for swiveling. The surfaces of the upper and lower housings are rounded off to provide a smooth exterior.

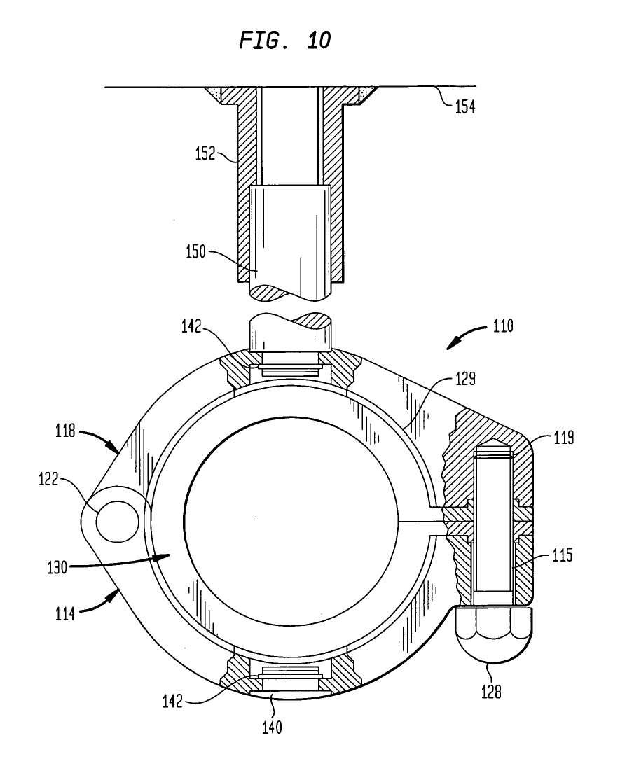

FIG. 10 shows the pipe and tube support shown in FIG. 9 interconnected with a suspension rod 150 which is interconnected with a suspension housing 152 and which is attached to a support surface 154. The suspension rod 150 and/or the housing 152 can be adjusted to alter the distance from which the pipe and tube support 110 is positioned away from a support surface 154.

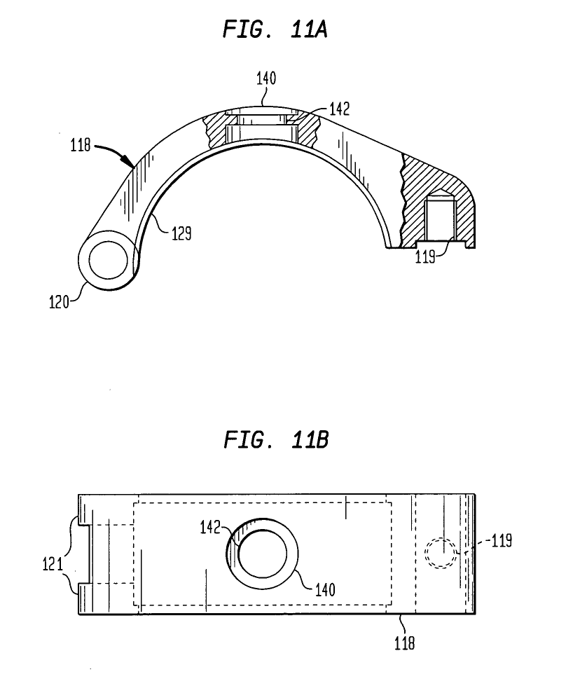

The upper housing 118 is shown from the side in FIG. 11A and from the top in FIG. 11B. As can be seen, the upper housing 118 includes a fastening aperture 119, a suspension receptacle 140 with a snap ring 142 and a hinge aperture 120 for receiving a hinge pin, not shown, that extends through the upper and lower housings, 114 and 118, to engage the upper and lower housings in a clam-shell fashion. Also shown are ridges 129 that are formed on an interior surface of the housing for the purpose of properly seating liner 130, not shown. FIG. 11B shows a top view of the upper housing showing the suspension receptacle 140 and snap ring 142 along with the fastening aperture 119. As can be seen from FIGS. 11A and 11B, the hinge aperture 120 extends through hinge recess fingers 121.

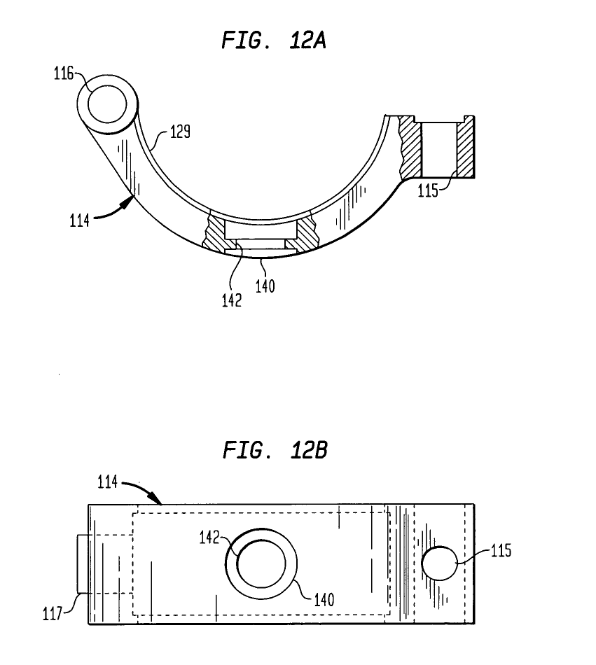

The lower housing 14 is shown from the side in FIG. 12A and from the bottom in FIG. 12B. As can be seen, the lower housing 114 includes a fastening aperture 115, a suspension receptacle 140 with a snap ring 142 and a hinge aperture 116 for receiving a hinge pin, not shown, that would extend through the lower housing 114 and the upper housing 118 to engage the upper and lower housings in a clam-shell fashion. Also shown are ridges 129 that are formed on an interior surface of the lower housing 114 for the purpose of properly seating liner 130, not shown. FIG. 12B shows a bottom view of the lower housing showing the suspension receptacle 140 and snap ring 142 along with the fastening aperture 115. As can be seen from FIGS. 12A and 12B, the hinge aperture 116 is positioned on hinge projection 117 which fits between hinge fingers 121 on upper housing 118. Thereafter, a hinge pin, not shown, is inserted to join the upper and lower housings in a clam-shell fashion.

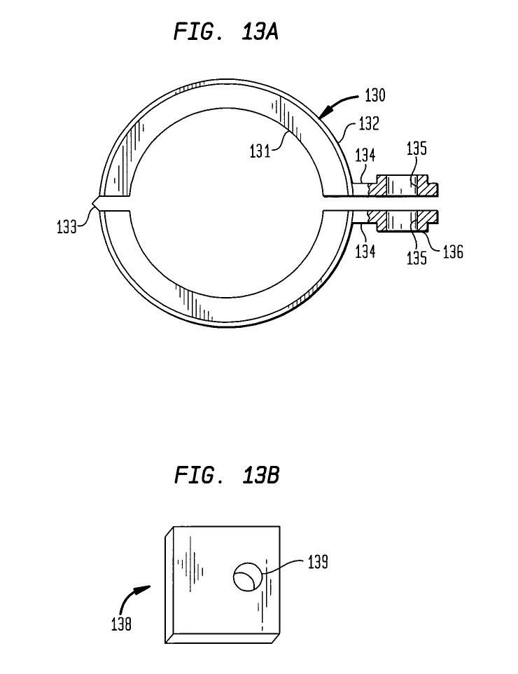

FIG. 13A shows the liner 130 for positioning within the lower housing 114 and upper housing 118. The liner 130 includes a smooth interior surface for extending about, or engaging, a pipe, not shown. The liner 130 has an outer surface 132 that is positioned in contact with the inner surfaces of the lower and upper housings 114 and 118. Accordingly, recesses can be formed on the liner 130 to engage with ridges on the inner surfaces of the lower and upper housings 114 and 118 for seating the liner 130 in the housing. The liner 130 can be provided with a living hinge 133 which permits the liner 130 to open and close with the lower and upper housings 114 and 118. Any of the embodiments of this invention can use a liner with a living hinge, if desired. Indeed, the inner surfaces of the liner 130, and the body of the liner itself, can be interrupted at the living hinge 133 to allow for such opening and closing movement. The liner 130 includes fastening arms 134 and fastening-extensions 136 for extending between the lower and upper housings 114 and 118 at the fastening ends. The fastening portion 136 includes aligned apertures 135 for accommodating a fastening screw. These fastening arms 134 and fastening extensions 136, as well as the liner body are unconnected to allow for opening and closing of the liner 130.

FIG. 13B shows an insert or shim, 138 which can be inserted between the attachment arms and extensions 134 and 136. An aperture 139 is provided in shim 138 that is aligned with apertures 35 for accommodating the attachment bolt. This insert can be used in situations where it is not desirable for the pipe and tube support 110 and the liner 130, to fully engage a pipe or tube. The insert prevents over tightening of the pipe and tube support 110 and can be used as a spacer to allow for extra room between the pipe and tube support 110 and liner 130 on the one hand, and a pipe or tube on the other. As shown in FIG. 13C, this can also be accomplished by providing stops 237 having an increased thickness to liner 230 at fastening arms 234 and/or fastening extensions 236. As such, a pipe or tube can thermally expand unencumbered while resting in the pipe and tube support. Importantly, the insert or stops can be used with any embodiment of the present invention.

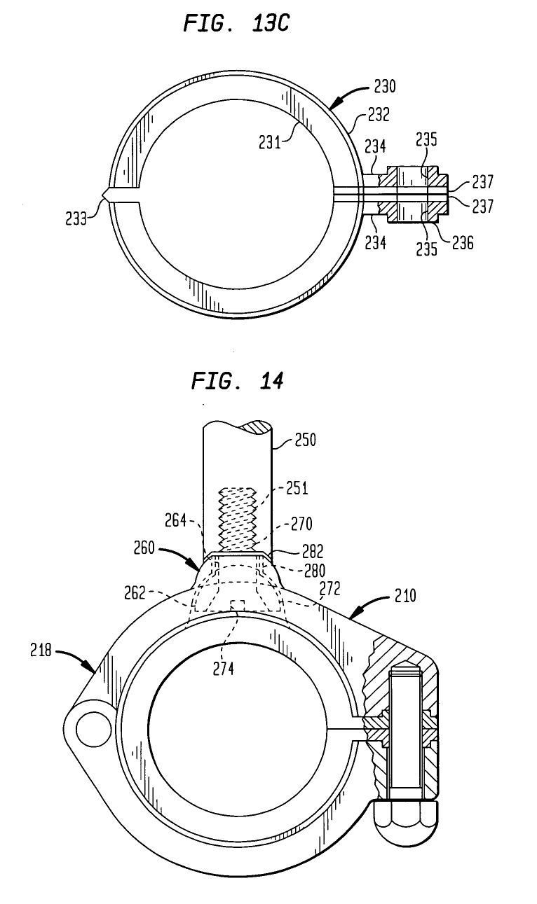

FIG. 14 shows another embodiment of the pipe and tube support 210 wherein the attachment between upper housing 218 and suspension rod 250 allows for movement between the pipe and tube support and the suspension rod. Upper housing 218 includes a domed protrusion 260 having a domed interior 262. The protrusion 260 in the upper housing 218 includes an aperture 264 at the apex. An attachment bolt 270 having a domed shaped head 272 with a driving slot 274 extends through the aperture 264 in the upper housing 218 and can be threadably engaged with threads 251 on suspension rod 250. The lower end of the suspension rod has a complimentary domed receptacle shape for receiving the domed protrusion 260. A collar 280 having a cylindrical shape is positioned within or formed as a part of the aperture 264 in protrusion 260 of upper housing 218. This collar 280 has a height that exceeds the dimension of the thickness of the protrusion 260 where the aperture is positioned. The collar 280 prevents the rigid fixation of the pipe and tube support 210 to the suspension rod 250 and provides play to permit the pipe and tube support 210 to swivel and rock with respect to the suspension rod 250. A domed shaped washer 282, or even an O-ring, can be positioned between the top of the domed protrusion 260 and the suspension rod to close any gaps therebetween and dampen movements. The washer 282 is preferably made of a plastic material.

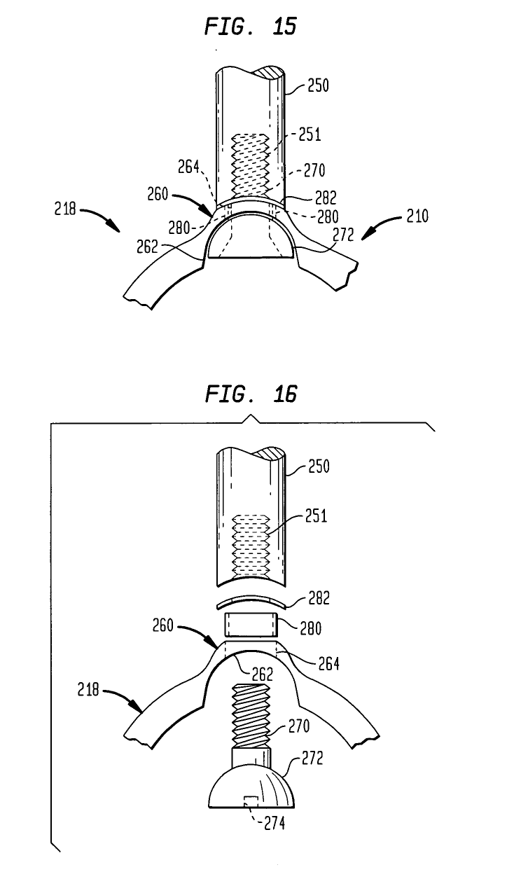

FIG. 15 is a close-up view showing a broken away portion of the upper housing 218 of pipe and tube support 210. The domed protrusion 260 is shown with the domed interior 262. The aperture 264 through the protrusion 260 is shown. Attachment bolt 270 extends through the aperture 264 and is engaged in any desired manner such as by threads 251 with suspension rod 250. Collar 280 is provided to prevent the attachment bolt 270 from being over tightened and thus prevents rigid engagement between the pipe and tube support 210 and the suspension rod 250. Washer 282 is used to close gaps and dampen movement.

FIG. 16 is an exploded view of the pipe and tube support shown in FIG. 15. The domed protrusion 260 is shown with the domed interior 262 and aperture 264 therethrough. The attachment bolt 270 extends through the aperture 264 and is engaged with the threads 251 on extension rod 250. Collar 280 is positioned within the aperture 264 between the domed shaped head 272 of the attachment bolt 270 and the underside of suspension rod 250. Domed shaped washer 282 is positioned between the domed shaped protrusion 260 and the suspension rod 250 to close gaps and dampen movements.

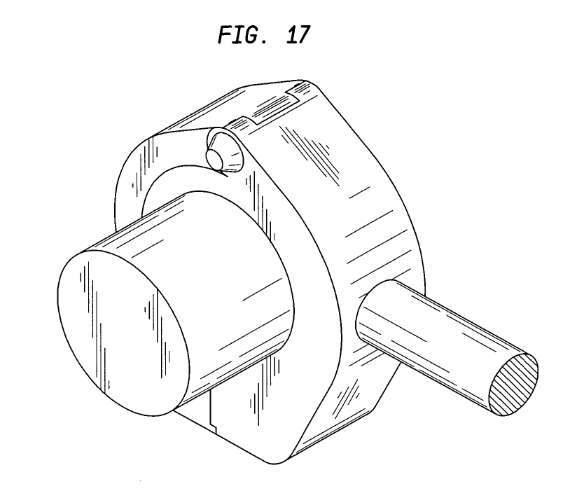

FIG. 17 shows a perspective of an embodiment of the invention positioned on a pipe, wherein a suspension rod is fixedly attached to the housing.

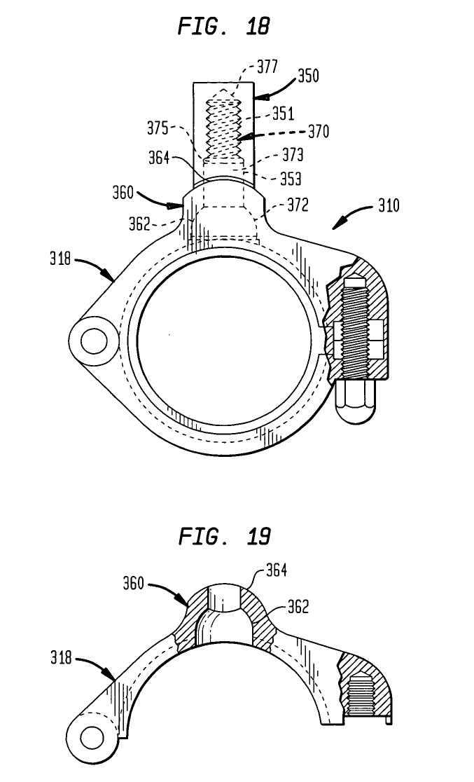

FIG. 18 shows another embodiment of the pipe and tube support 310 wherein the attachment between upper housing 318 and suspension rod 350 allows for movement between the pipe and tube support and the suspension rod. Upper housing 318 includes a domed protrusion 360 having a domed interior 362. The protrusion 360 in the upper housing 318 includes an aperture 364 at the apex. An attachment bolt 370 having a domed shaped head 372 and cylindrical body portion 373 extends through the aperture 364 in the upper housing 318. The cylindrical portion 373 ends at shoulder 375 and threaded portion 377 extends therefrom and can be threadably engaged with threads 351 on suspension rod 350. The threads 351 on the suspension rod 350 are recessed from the lower end. An enlarged cylindrical bore 353 extends from the lower end to the recessed threads, and can accommodate the cylindrical portion 373 of attachment bolt 370. A step down 355 from the cylindrical bore 353 to the threads 351 coacts with shoulder 375 to limit the extent to which the attachment bolt 370 can be engaged with suspension rod 350. The lower end of the suspension rod 350 has a complimentary domed receptacle shape for receiving the domed protrusion 360, and when the attachment bolt 370 is engaged with the suspension rod 350, a gap exists between the lower end of the suspension rod 350 and domed protrusion 360. Accordingly, rigid fixation of the pipe and tube support 310 with the suspension rod 350 is prevented and the pipe and tube support 310 can swivel and rock with respect to the suspension rod 350.

FIG. 19 shows the upper housing 318 shown in FIG. 18 including domed protrusion 360, with domed interior 362, and aperture 364 for receiving attachment bolt 370.

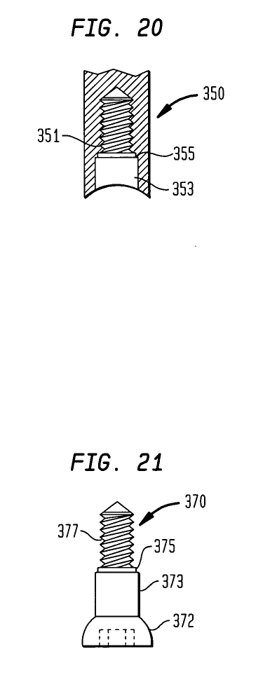

FIG. 20 shows the lower end of suspension rod 350. The lower end includes a lower domed receptacle shape for receiving the domed protrusion 360 of the pipe and tube support 310. Extending from the cylindrical bore 353 is a step down 355 to threaded portion 375 for receiving the attachment bolt 370.

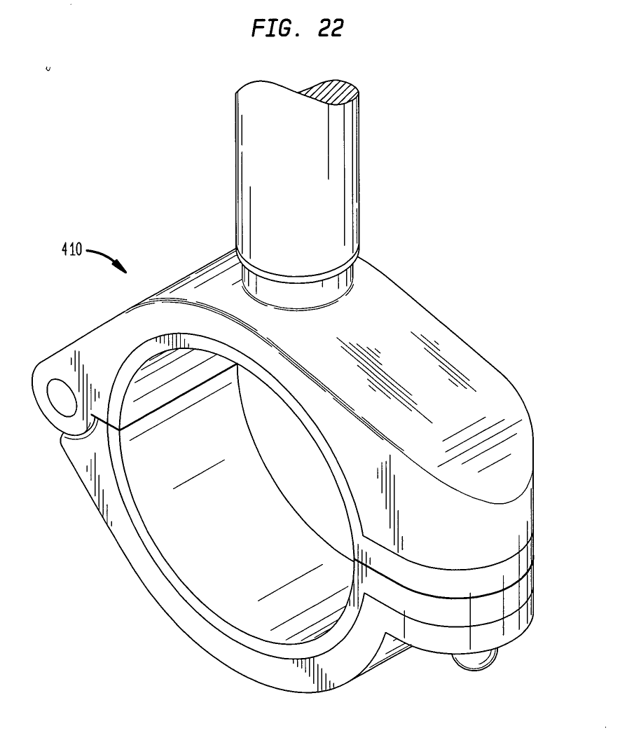

FIG. 21 shows an attachment bolt 370 having a domed shaped head 372, a cylindrical body portion 373, a shoulder 375 and a threaded portion 377. In use, the attachment bolt 370 is engaged with the lower end of the suspension rod 350 by inserting the attachment bolt 370 through the cylindrical bore 353 and engaging threads 351 on the attachment bolt with threads 351 in the suspension rod 350. The cylindrical portion 373 of the attachment bolt 370 extends into the enlarged cylindrical bore 353, the shoulder 375, contacting the step down 355 to prevent over engagement of the attachment bolt 370 with the suspension rod 350. The pipe and tube support 310, which rides on the attachment bolt 370 can thus swivel and tilt.

FIG. 22 shows a perspective view of another embodiment of the pipe and tube support 410 of the present invention.

The pipe and tube supports of the present invention can be used with a pipe that slopes to accommodate the slope by moving or rocking to position the interior surfaces of the liner to be parallel to the pipe. This reduces any pressure points.

The housing can be cast by any known method such as investment casting (lost wax method). Any metal can be used such as stainless steel for sterile environments or carbon steel for less restrictive environments.

In use, the upper and lower housings are interconnected by a hinge and provided in a clam shell configuration. An appropriate sized liner can be snapped into the housing and a bolt may be interconnected with one of the upper or lower housings. In the field, the device can be positioned about a pipe, and the fastening screw engaged to provide quick and easy installation of the pipe and tube support. The fastening bolt could be an acorn head bolt which is easy to use in the field. The bolt could be captured in the lower housing to reduce parts and make installation easier. If desirable, an insert can be inserted at the bolt end to prevent the device from being over tightened and to allow the pipe and tube support to function as an expansion guide. Because of the smooth shape of the overall device, it can be quickly and easily cleaned and is suitable for clean room applications. Also, there are no loose pieces at the point of construction, but rather, the device can be fully constructed prior to shipment. Because of its ability to swivel and rock, the pipe and tube support does not have to be positioned exactly during installation, further increasing the ease of installation. The housings can be cast or formed in any suitable manner and different sized pipes can be accommodated in one size housing by utilization of different thickness liners.

Having thus described the invention in detail, it is to be understood that the foregoing description is not intended to limit the spirit and scope thereof. What is desired to be protected by Letters Patent is set forth in the appended claims.

1. A pipe and tube support apparatus comprising:
a housing including an upper housing portion, a lower housing portion hingedly interconnected to the upper housing portion, and a fastener for fastening the upper and lower housing portions in a closed position;
upper and lower liners positioned within the upper and lower housing portions to form a cylindrical inner surface;
means for interconnecting the housing to a suspension member; and
means for angling the housing with respect to the suspension member to accommodate a sloping pipe or tube.

2. The apparatus of claim 1, wherein the upper housing portion comprises a dome-shaped protrusion and an elongate aperture in the protrusion.

3. The apparatus of claim 2, wherein the suspension member comprises a dome-shaped recess formed in an end of the suspension member and corresponding to the dome-shaped protrusion.

4. The apparatus of claim 2, wherein the means for angling the housing comprises a dome-headed bolt inserted through the elongate aperture of the dome-shaped protrusion and threadably engageable with a threaded aperture in an end of the suspension member, the dome-headed bolt coacting with a dome-shaped interior of the dome-shaped protrusion to allow the housing to angle with respect to the suspension member.

5. The apparatus of claim 4, further comprising a shoulder on the screw for limiting threading of the screw into the threaded aperture.

6. The apparatus of claim 3, further comprising an O-ring positioned between the dome-shaped protrusion and the dome-shaped recess.

7. The apparatus of claim 3, further comprising a dome-shaped washer positioned between the dome-shaped protrusion and the dome-shaped recess.

8. The apparatus of claim 4, further comprising a collar positioned about the dome headed bolt and between the bolt and the elongate aperture.

9. The apparatus of claim 8, wherein the collar extends above the dome-shaped protrusion and prevents contact between the dome-shaped protrusion and the suspension member.

10. The apparatus of claim 1, wherein the fastener for fastening the upper and lower housing portions comprises an acorn bolt.

11. The apparatus of claim 1, further comprising a living hinge interconnecting ends of the upper and lower liners.

12. The apparatus of claim 1, wherein the upper and lower liners include grooves which coact with shoulders on the upper and lower housing portions to seat the upper and lower liners in the upper and lower housing portions.

13. The apparatus of claim 1, further comprising an end groove formed on a first end of each of the upper and lower liners for engaging a first set of tabs formed in each of the upper and lower housing portions; and a slot formed in an opposite end of each of the upper and lower liners for engaging tabs formed in the upper and lower housing portions to retain the upper and lower liners to the upper and lower housing portions.

14. The apparatus of claim 1, further comprising an insert positionable between the upper and lower liners to prevent over-tightening of the fastener.

15. The apparatus of claim 1, further comprising stops formed on the upper and lower liners to prevent over-tightening of the fastener.

16. A method for supporting a pipe or tube comprising:
providing a housing having an upper housing portion and a lower housing portion hingedly interconnected at first ends and releasably attachable at opposite ends;
snapping liners into position on interior surfaces of the housing;
positioning a pipe or tube against the liner;
positioning the housing and liners about the pipe or tube;
attaching the upper and lower housing portions together about the pipe or tube, and
suspending the housing from a surface.

17. The method of claim 16, further comprising adjusting the angulation of the housing to accommodate a sloped pipe or tube.

18. The method of claim 16, wherein the upper and lower housing portions are attachable by a bolt and the method further comprises capturing the bolt in the lower housing portion.
